(19) United States
(12) Patent Application Publication
(10) Pub. No.: US 2022/0248651 A1
(43) Pub. Date: Aug. 11, 2022

(54) SYSTEMS, METHODS, AND APPARATUSES FOR ENHANCED FISHING LURE GYRATION

(71) Applicant: Andrew Alton Larsen, Happy Valley, OR (US)

(72) Inventor: Andrew Alton Larsen, Happy Valley, OR (US)

(21) Appl. No.: 17/667,393

(22) Filed: Feb. 8, 2022

Related U.S. Application Data
(60) Provisional application No. 63/147,047, filed on Feb. 8, 2021.
(60) Provisional application No. 63/162,465, filed on Mar. 17, 2021.
(60) Provisional application No. 63/162,958, filed on Mar. 18, 2021.
(60) Provisional application No. 63/163,541, filed on Mar. 19, 2021.

(51) Int. Cl. A01K 85/00; A01K 85/12

(52) U.S. Cl. CPC A01K 85/1883; A01K 85/029; A01K 85/122

(57) ABSTRACT

Systems, methods, and apparatuses for enhanced fishing lure gyration are described herein. For example, according to one embodiment there is a method for luring fish for ensnarement via inducing fish bait mobility, including: threading a fishing line in through an ingress opening of an anterior base portion of a buoyant fishing lure and out through an egress opening of a posterior base portion of the fishing lure, in which the fishing line traverses a channel connecting the ingress opening and the egress opening, in which the egress opening is to receive a base portion of a connector hook, in which the lure further has an asymmetrical curved blade portion extending peripherally outward from the anterior base portion of the central core portion, in which the asymmetrical curved blade portion includes: an anterior blade surface having a smooth texture configured to reduce fluid drag from water current, a posterior blade surface with integrated indentations, wherein the integrated indentations are to receive scented material to be affixed and positioned within recesses of the integrated indentations, in which the scented material is to be dissipated over an attached fishing bait posterior to the posterior blade surface as the fishing lure moves within a body of water, and an edge formed from an interface of the anterior blade surface and the posterior blade surface having a thickness configured to increase peripheral visibility; connecting the fishing line to accessories posterior to the posterior base portion, including one or more of: (i) fishing bait, (ii) floats, and (iii) ensnarement mechanisms including hooks; connecting the fishing line to one or more of: (i) fishing tackle including a bead chain swivel, and (ii) a fishing vessel located anteriorly to the anterior base portion; deploying the fishing lure having the threaded fishing line and connected accessories into a body of water; applying a force on the fishing line to induce movement of the fishing lure and the connected accessories within the body of water, in which the movement is induced by the asymmetric curved blade portion of the lure swiveling in an off-center rotating motion-counter motion of less than 360 degrees, in which the rotating motion-counter motion of the blade portion rotates the fishing line and the connected accessories in a combined rotating-oscillating motion; dissipating, pursuant to the movement of the fishing line, the scented material into the body of water; attracting, pursuant to the movement and the dissipating, fish in the body of water towards the fishing lure having the threaded fishing line and the connected accessories; and ensnaring the fish as they come into contact with the ensnarement mechanisms connected to the fishing lure. Other related embodiments are disclosed.

### CLAIM OF PRIORITY

This non-provisional U.S. Utility Patent Application is related to, and claims priority to, the U.S. Provisional Patent Application No. 63/147,047, entitled “FISHING LURE” filed Feb. 8, 2021, and is further related to, and claims priority to U.S. Provisional Patent Application No. 63/162,465, entitled “DNA . . . A FISHING LURE . . . A REAL REPRESENTATION OF A HERRING . . . ,” filed Mar. 17, 2021, and is further related to, and claims priority to U.S. Provisional Patent Application No. 63/162,958, entitled “WACKO . . . A FISHING LURE . . . TO CATCH FISH,” filed Mar. 18, 2021, and is further related to, and claims priority to U.S. Provisional Patent Application No. 63/163,541, entitled “SNUBNOSE MAKES BAIT DIVE, DART, AND WIGGLE,” filed Mar. 19, 2021, the entire contents of each being incorporated herein by reference as though set forth in full.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments disclosed herein relate generally to the field of fishing tackle and more particularly, disclosed embodiments relate to systems, methods, and apparatuses for enhanced fishing lure gyration.

### BACKGROUND

The subject matter discussed in the background section is not to be considered prior art merely because of its mention in the background section. Similarly, a problem mentioned in the background section or associated with the subject matter of the background section shall not be considered to have been previously recognized in the prior art. The subject matter in the background section merely represents different approaches, which in and of themselves, may also correspond to claimed embodiments.

Fishing tackle including various ways to lure and ensnare fish and other marine fauna has a long history paralleling humankind's hunting rituals and recreation. From primitive poles and sticks to modern methods of sonar and other technologies, fishing in various bodies of water including rivers, streams, lakes, and ponds has attracted numerous sportsmen, hunters, and nature lovers seeking food, recreation, and/or relaxation. As time progresses, ways to ensnare fish have become more advanced, including the use of fishing bait such as hoochies (a type of fishing lure accessory often shaped as a squid body with a skirt that partially obscures a hook), as well as other artificial imitations of fish and marine life, as well fishing vessels and tackle used to assist with the navigation of fishing lures when deployed in a body of water.

Problematically, fishing lures are often limited in features and their ability to imitate movements that mimic the movements of fish or to exhibit complicated and agile movements that can optimally provide visual and kinetic stimuli to attract fish to a lure for ensnarement. Furthermore, fishing lures need features to help them withstand the brunt of water current and other forces in a body of water.

What is needed is a way to allow fishing lures to move in complicated rotational and gyratory motions to imitate the range of movement of fish or a range of movement to better attract fish to a lure for ensnarement. The present state of the art may therefore benefit from the systems, methods, and apparatuses for enhanced fishing lure ensnarement.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1A depicts an exemplary view of a fishing lure in an upright orientation, in accordance with described embodiments;

FIG. 1B depicts an exemplary view of a fishing lure packaging, in accordance with described embodiments;

FIG. 2 depicts an exemplary view of a fishing lure in vertical downwards orientation, in accordance with described embodiments;

FIG. 3 depicts an exemplary anterior flat view of a fishing lure in vertical downwards orientation, in accordance with described embodiments;

FIG. 4 depicts an exemplary posterior flat view of a fishing lure in vertical downwards orientation, in accordance with described embodiments;

FIG. 5 depicts an exemplary anterior view of a blade for a fishing lure in an upright orientation, in accordance with described embodiments;

FIG. 6 depicts an exemplary posterior inverted view of a blade for a fishing lure, in accordance with described embodiments;

FIG. 7 depicts an exemplary partial perspective view of a central core portion and blade of a fishing lure in a downwards orientation, in accordance with described embodiments;

FIG. 8 depicts an exemplary view of the fishing lure in use with a fishing line, fishing bait, and hooks, in accordance with described embodiments;

FIG. 9 depicts an exemplary view of the fishing lure in motion, in accordance with described embodiments;

FIG. 10 depicts an exemplary view of a fishing lure packaging, in accordance with described embodiments;

FIG. 11 depicts an exemplary view of a fishing lure in an upright orientation, in accordance with described embodiments;

FIG. 12 depicts an exemplary flat view of a fishing lure in vertical downwards orientation, in accordance with described embodiments;

FIG. 13 depicts an exemplary posterior view of a blade for a fishing lure in an upright orientation, in accordance with described embodiments;

FIG. 14 depicts an exemplary view of the fishing lure in use with a fishing line, fishing bait, and hooks, in accordance with described embodiments;

FIG. 15 depicts an exemplary view of the fishing lure in motion, in accordance with described embodiments;

FIG. 16 depicts another exemplary view of the fishing lure in motion, in accordance with described embodiments;

FIGS. 17A-17C depict a flow diagram illustrating a method for luring fish for ensnarement via inducing fish bait mobility, in accordance with disclosed embodiments; and

FIGS. 18A-18C depict a flow diagram illustrating a method for luring fish for ensnarement via inducing fish bait mobility, in accordance with disclosed embodiments.

### DETAILED DESCRIPTION

Described herein are systems, methods, and apparatuses for enhanced fishing lure gyration.

For example, according to one embodiment there is a method for luring fish for ensnarement via inducing fish bait mobility, including: threading a fishing line in through an ingress opening of an anterior base portion of a buoyant fishing lure and out through an egress opening of a posterior base portion of the fishing lure, in which the fishing line traverses a channel connecting the ingress opening and the egress opening, in which the egress opening is to receive a base portion of a connector hook, in which the lure further has an asymmetrical curved blade portion extending peripherally outward from the anterior base portion of the central core portion, in which the asymmetrical curved blade portion includes: an anterior blade surface having a smooth texture configured to reduce fluid drag from water current, a posterior blade surface with integrated indentations, wherein the integrated indentations are to receive scented material to be affixed and positioned within recesses of the integrated indentations, in which the scented material is to be dissipated over an attached fishing bait posterior to the posterior blade surface as the fishing lure moves within a body of water, and an edge formed from an interface of the anterior blade surface and the posterior blade surface having a thickness configured to increase peripheral visibility; connecting the fishing line to accessories posterior to the posterior base portion, including one or more of: (i) fishing bait, (ii) floats, and (iii) ensnarement mechanisms including hooks; connecting the fishing line to one or more of: (i) fishing tackle including a bead chain swivel, and (ii) a fishing vessel located anteriorly to the anterior base portion; deploying the fishing lure having the threaded fishing line and connected accessories into a body of water; applying a force on the fishing line to induce movement of the fishing lure and the connected accessories within the body of water, in which the movement is induced by the asymmetric curved blade portion of the lure swiveling in an off-center rotating motion-counter motion of less than 360 degrees, in which the rotating motion-counter motion of the blade portion rotates the fishing line and the connected accessories in a combined rotating-oscillating motion; dissipating, pursuant to the movement of the fishing line, the scented material into the body of water; attracting, pursuant to the movement and the dissipating, fish in the body of water towards the fishing lure having the threaded fishing line and the connected accessories; and ensnaring the fish as they come into contact with the ensnarement mechanisms connected to the fishing lure.

According to another embodiment there is a method for luring fish for ensnarement via inducing fish bait mobility, the method including: threading a fishing line in through an anterior ingress opening of a base portion of a buoyant fishing lure and out through a posterior egress opening of the base portion of the fishing lure, in which the fishing line traverses a channel connecting the ingress opening and the egress opening, in which the fishing line connects to accessories downstream of the egress opening, in which the lure further has an asymmetrical curved blade portion extending peripherally outward from the base portion, in which the asymmetrical curved blade portion includes: an anterior blade surface having a smooth texture configured to reduce fluid drag from water current, a posterior blade surface with integrated indentations, in which the integrated indentations are to receive scented material to be affixed and positioned within recesses of the integrated indentations, in which the scented material is to be dissipated over an attached fishing bait posterior to the posterior blade surface as the fishing lure moves within a body of water, and an edge formed from an interface of the anterior blade surface and the posterior blade surface having a thickness configured to increase peripheral visibility; connecting the fishing line to accessories posterior to the base portion; connecting the fishing line to one or more of: (i) fishing tackle including a bead chain swivel, and (ii) a fishing vessel located anteriorly to the base portion; deploying the fishing lure having the threaded fishing line and connected accessories into a body of water; applying a force on the fishing line to induce movement of the fishing lure and the connected accessories within the body of water, in which the movement is induced by the asymmetric curved blade portion of the lure swiveling in an off-center rotating motion-counter motion of less than 360 degrees, in which the rotating motion-counter motion of the blade portion is translated posteriorly down the fishing line, in which the accessories are perturbed to move in a chirp vibrating-twitching motion; dissipating, pursuant to the movement of the fishing line, the scented material into the body of water; attracting, pursuant to the movement and the dissipating, fish in the body of water towards the fishing lure having the threaded fishing line and the connected accessories; and ensnaring the fish as they come into contact with the ensnarement mechanisms connected to the fishing lure.

In the following description, numerous specific details are set forth such as examples of specific configurations, use cases, materials, components, etc., in order to provide a thorough understanding of the various embodiments. It will be apparent, however, to one skilled in the art that these specific details need not be employed to practice the embodiments disclosed herein. In other instances, well-known materials or methods have not been described in detail in order to avoid unnecessarily obscuring the disclosed embodiments.

In addition to various hardware components depicted in the figures and described herein, embodiments further include various operations described below. The operations described in accordance with such embodiments may be performed by specially manufactured components or may utilize general-purpose components in certain instances to realize and perform the innovative function and configuration of the described embodiments. Alternatively, the operations may be performed by a combination of customized specially manufactured components with certain general-purpose components to make, use, and practice the inventive aspects as set forth herein.

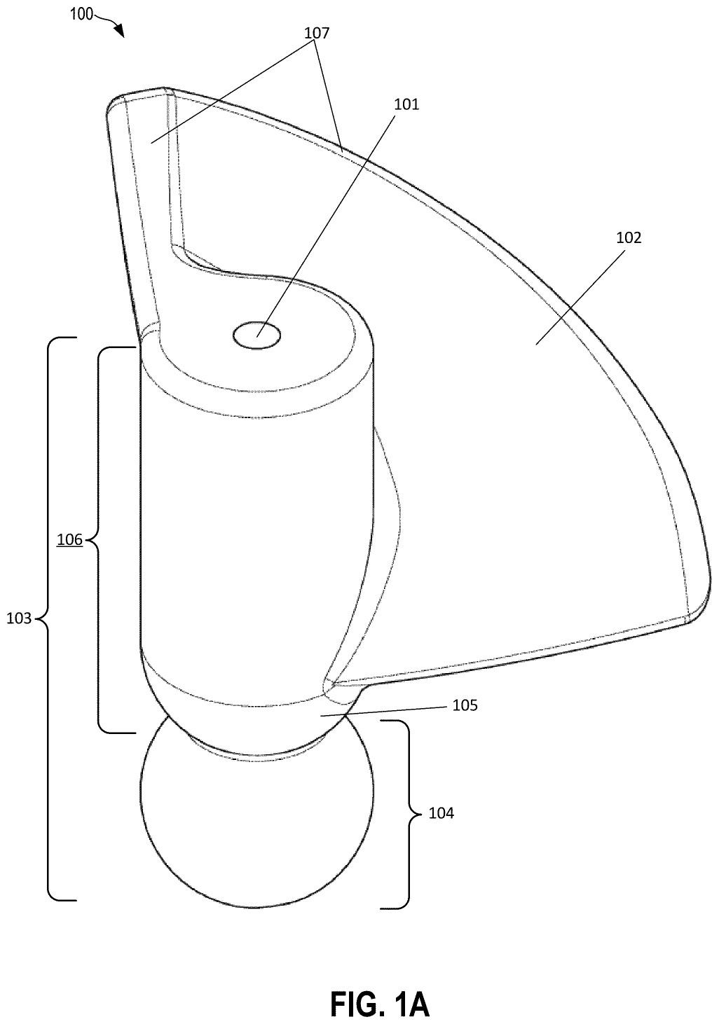

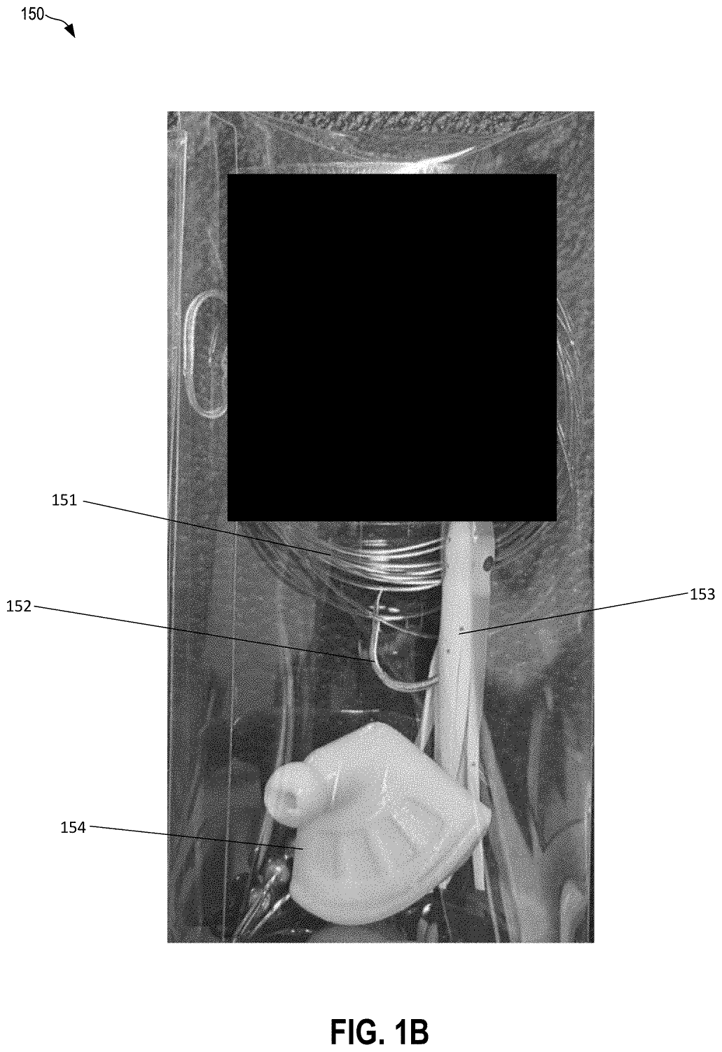

FIG. 1A depicts an exemplary view of a fishing lure in an upright orientation 100, in accordance with described embodiments.

As shown here, there is a fishing lure 100 having blade 102, edge 107 extending across the perimeter of the blade, anterior ingress opening 101 of a central core 103 having an anterior base portion 106 with a neck portion 105 and a posterior base portion 104. Anterior ingress opening 101 may receive a fishing line to thread through central core 103. According to certain embodiments, accessories such as hooks, hoochie type lures, etc. may be attached to a portion of the fishing line. According to certain embodiments, blade 102 may be made of an auger material and may have various curvatures, angles, and textures including various slits or other openings on the blade surface.

FIG. 1B depicts an exemplary view of a fishing lure packaging 150, in accordance with described embodiments.

As shown here, fishing lure 154 may have different colors and materials and be packaged and sold with a hook 152 and fishing line 151. According to certain embodiments, portions of fishing lure 154 such as edge 107 may be different colors than other portions of fishing lure 154. According to other embodiments, other accessories such as hoochie 153 type lure may also be included in the packaging.

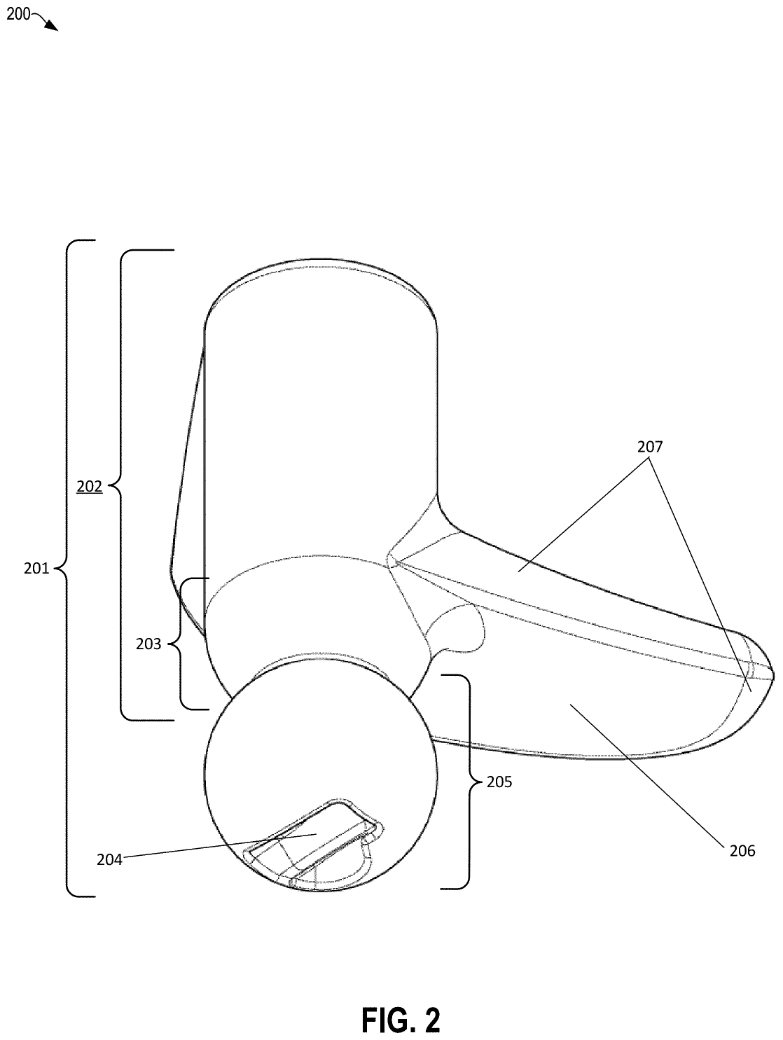

FIG. 2 depicts an exemplary view of a fishing lure in a downwards orientation 200, in accordance with described embodiments.

As shown here, fishing lure 200 has central core portion 201 including anterior base portion 202 having a neck portion 203 and posterior base portion 205 having egress opening 204. Asymmetrical curved blade portion 206 radiates outward from anterior base portion 202 and has edge 207 around the perimeter of asymmetrical curved blade portion 206. Edge 207 may be of a thickness configured to enhance peripheral visibility of fishing lure 200 to fish and marine life when fishing lure 200 is deployed in a body of water.

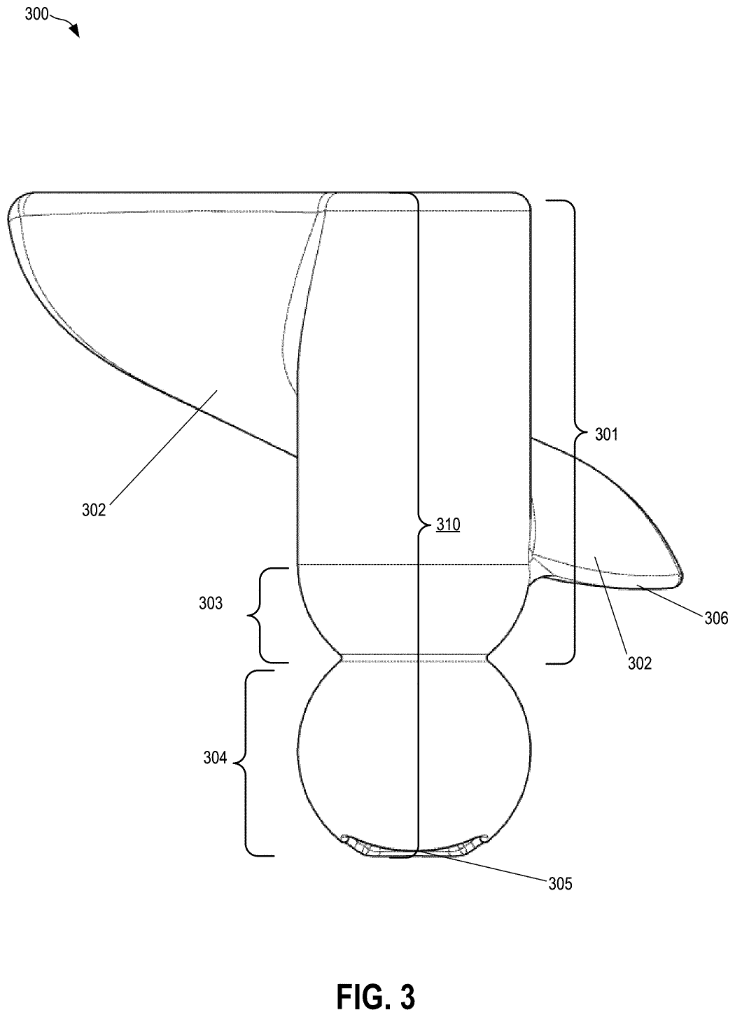

FIG. 3 depicts an exemplary anterior flat view of a fishing lure in a downwards orientation 300, in accordance with described embodiments.

As shown here, fishing lure 300 has central core portion 310 including anterior base portion 301 having a neck portion 303 and posterior base portion 301 having egress opening 305. Asymmetrical curved blade portion 302 radiates outward from anterior base portion 301 and has edge 306 around the perimeter of asymmetrical curved blade portion 302.

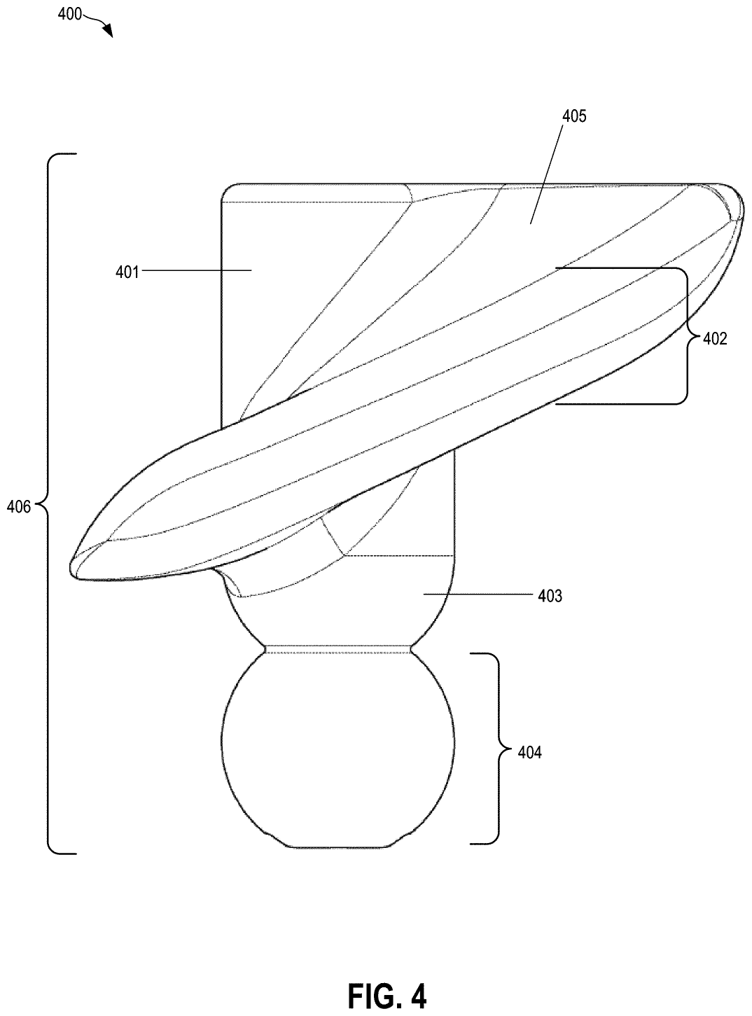

FIG. 4 depicts an exemplary posterior flat view of a fishing lure in a downwards orientation 400, in accordance with described embodiments.

As shown here, there is a central core portion 406 having a posterior base portion 404 and an anterior base portion 401 having a neck portion 403, as well as asymmetrical curved blade portion 405 having an edge 402.

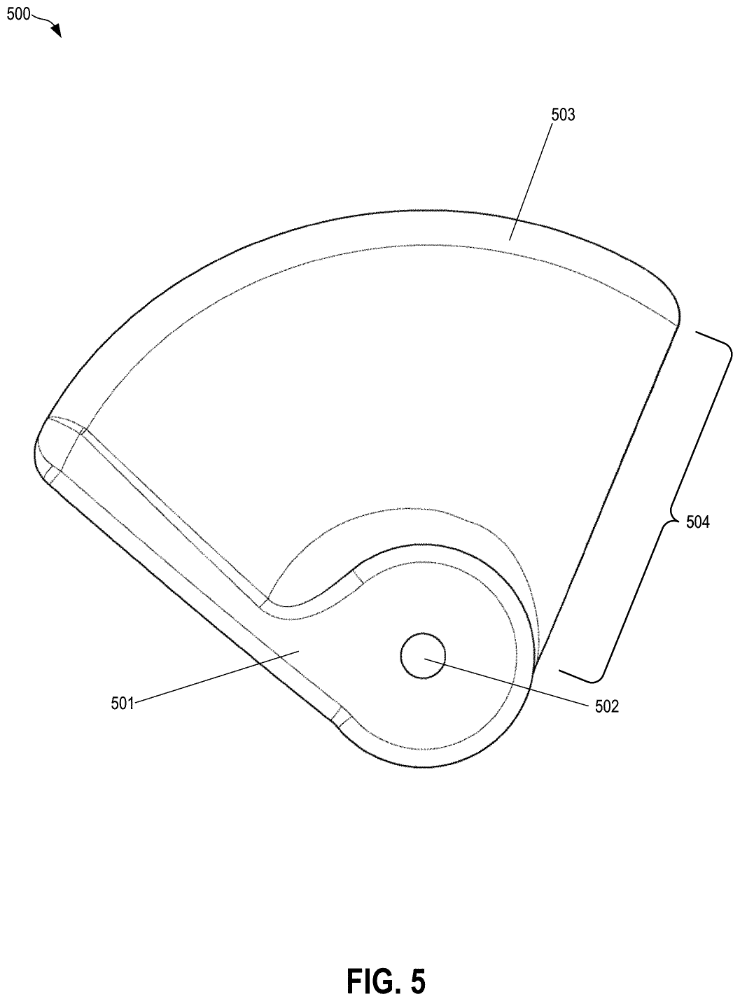

FIG. 5 depicts an exemplary anterior view of a blade 500 for a fishing lure in an upright position, in accordance with described embodiments.

As shown here, blade 500 has an opening 502 to be concentric with a channel inside central core 103 to receive a fishing line 151. According to certain embodiments, the anterior surface 504 of blade 500 is smooth. Edge 501 of blade 500 is also shown. Blade 500 may be an asymmetric curved blade of varying curvature and angles.

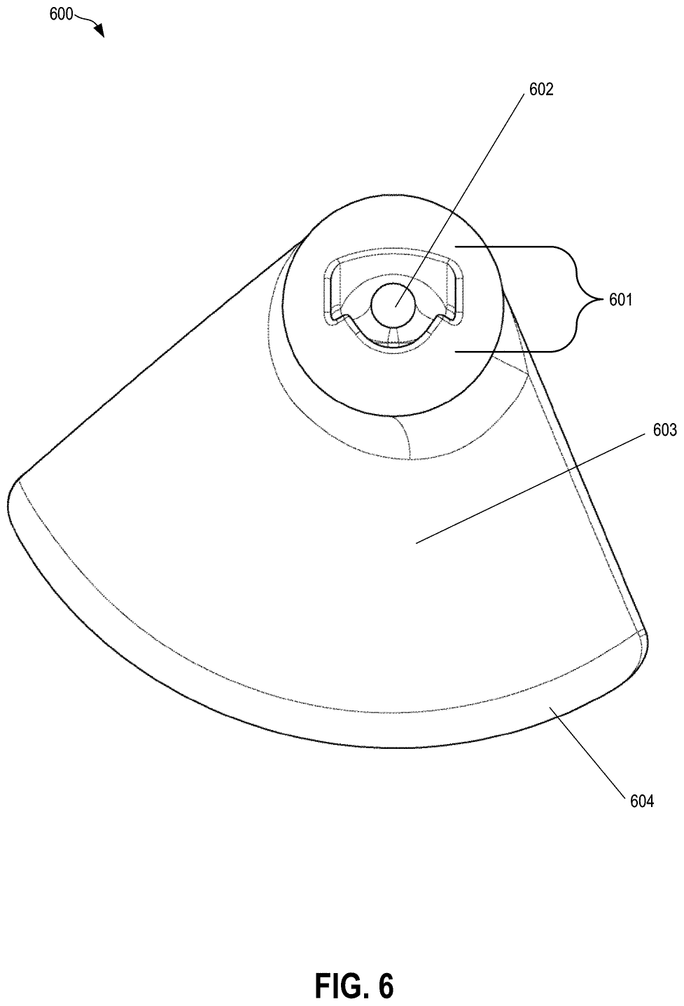

FIG. 6 depicts an exemplary posterior inverted view of a blade 600 for a fishing lure, in accordance with described embodiments.

As shown here, blade 600 has a recess 601 having an opening 602 to be concentric with a channel inside central core 103 to receive a fishing line 151. According to certain embodiments, the posterior surface 603 of blade 600 has integrated indentations 1404 to receive scented material for dissipation when fishing lure 100 is deployed in a body of water. These integrated indentations 1404 may also be known as scent stripes or scent strips and may vary in number, size, shape and dimensions according to the size of the integrated indentations 1404 themselves or the size of the posterior surface 603 of blade 600. Shapes of integrated indentations 1404 may include rectangles, squares, circles, parallelograms, diamonds, etc. For example, the length of the integrated indentations 1404 may be longer or shorter. According to certain embodiments, there may be five or fewer integrated indentations 1 404. According to other embodiments, there may be more than five integrated indentations 1404. Furthermore, the integrated indentations 1404 may have an ascending or descending length or size relative to each other, and may be arranged in various designs such as spokes radiating from a common point, as horizontal or vertical lines, or panels radiating in an arc.

Edge 604 of blade 500 is also shown. Blade 600 may be an asymmetric curved blade of varying curvature and angles.

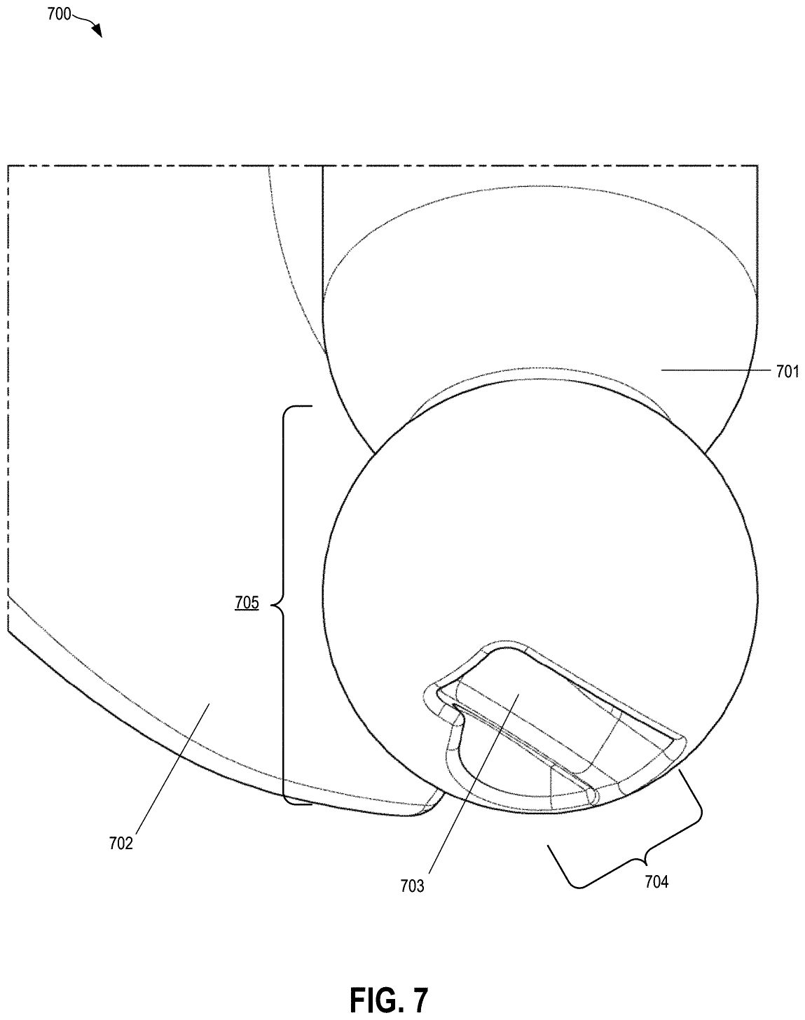

FIG. 7 depicts an exemplary partial perspective view of a base portion and blade 700 of a fishing lure in a downwards vertical orientation, in accordance with described embodiments.

As shown here, there is a neck 701 of an anterior base portion of a fish lure and a posterior base portion 705 having a recess 704 and egress opening 703. A portion of posterior surface 702 of a blade is also shown.

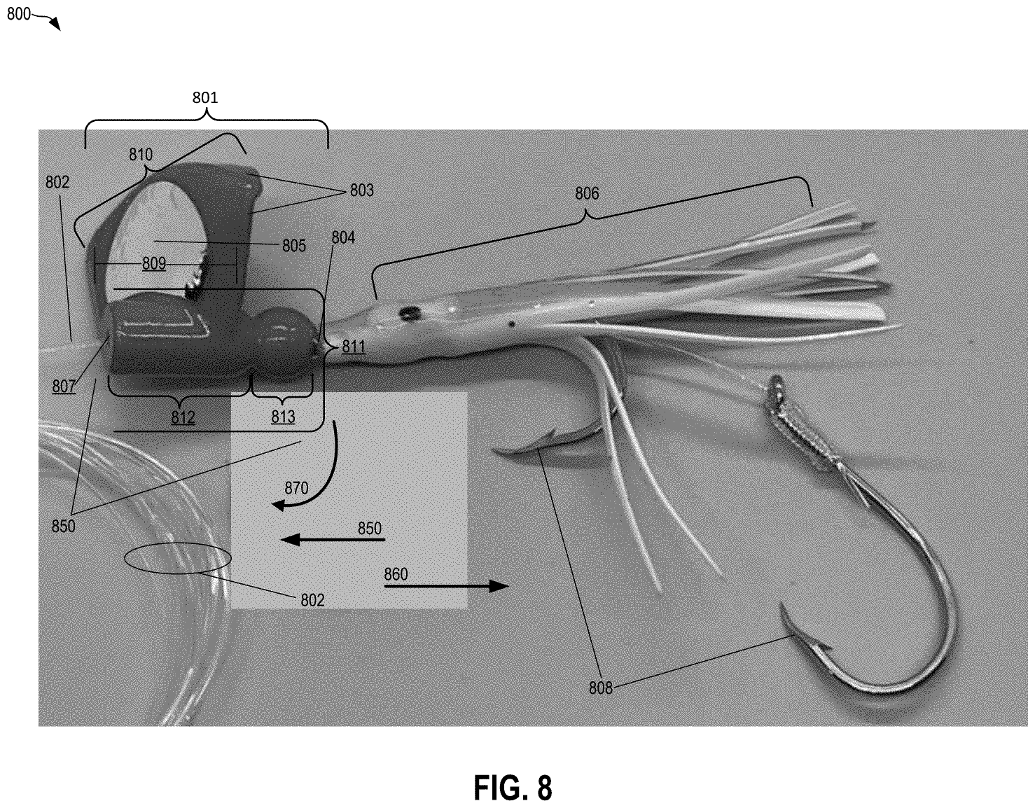

FIG. 8 depicts an exemplary view of the fishing lure in use with a fishing line, fishing bait, and hooks 800, in accordance with described embodiments.

As shown here, fishing lure 801 includes a central core portion 811 which includes an anterior base portion 812 and a posterior base portion 813, an asymmetric curved blade portion 810 radiating outward from anterior base portion 812 and having an anterior blade surface 809 and an edge 803 around the perimeter of blade portion 810.

According to certain embodiments, edge 803 has a thickness configured to increase peripheral visibility of fishing lure 801 to fish and other marine life during deployment of fishing lure 801 and attached accessories such as hoochie 806 and hooks 808.

According to certain embodiments, blade portion 810 swivels in an off-center rotating motion-counter motion of less than 360 degrees.

According to certain embodiments, blade portion 810 may have a chrome panel 809 of various shapes and sizes to reflect sunlight and provide long-range visual stimulation to attract fish when fishing lure 801 with threaded fishing line 802 and attached accessories such as hoochie 806 and hooks 808 are deployed in a body of water. Fishing line 802 threads into fishing lure 801 via ingress opening 807 of anterior base portion 812, traverses through a channel in central core 811 connecting ingress opening 807 and egress opening 804, and exits via egress opening 804 of posterior base portion 813 of central core 811.

As shown here, fishing bait such as hoochie 806 may attach to central core 811, for example via a hook connecting into egress opening 804 of posterior base portion 813. Other accessories such as hooks 808 may be connected to fishing line 802 via threading or tying. The direct connection of fishing bait such as hoochie 806 to central core 811 via a hook connection into egress opening 804 allows for a rotating motion-counter motion of blade portion 810 to translate rotation of the fishing line 802 into a combined rotating-oscillation motion of attached accessories such as hoochie 806 and hooks 808.

Fishing line 802 may be secured upstream 850 to a fishing vessel, for example using a bead chain swivel, or fishing tackle. Upstream 850 is in the direction of pulling force 850 applied to fishing line 802 to move fishing lure 801 and attached accessories 806 and 808 in a forwards direction. Counter to upstream/direction of pulling force 850 is the direction of water flow 860 which is downstream 860. Direction of water flow 860 is a resistance force against fishing lure 801, impacting anterior blade surface 809 of fishing lure 801 which serves to mitigate this force via the smooth surface of anterior blade surface 809 and to serve as a barrier to allow for slower release of scented material held in integrated indentations of the posterior surface of blade portion 810.

It should be further noted as shown here that there is a lack of symmetry 870 around central core 811, with blade portion 810 only radiating outward across a part of anterior base portion 812.

According to certain embodiments, fishing lure 801 or system 800 may be known as “The Felon.”

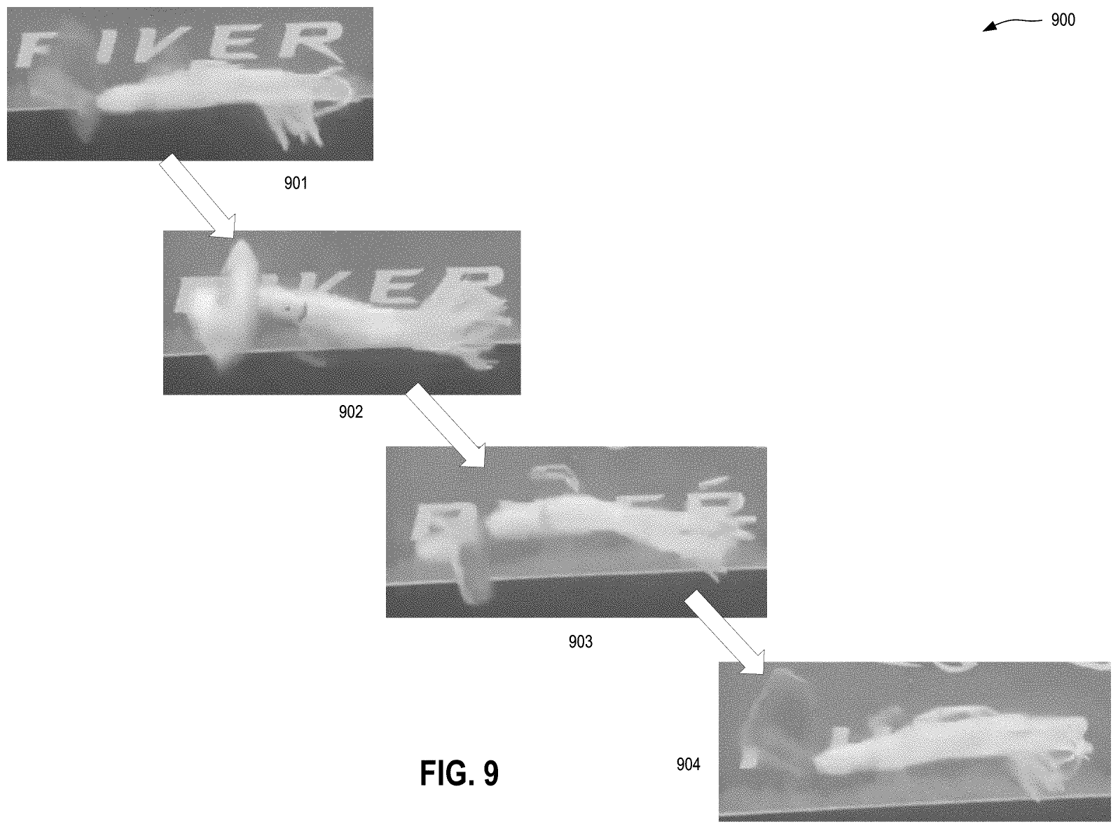

FIG. 9 depicts an exemplary view of the fishing lure in motion 900, in accordance with described embodiments.

As shown here, fishing lure 801 and attached accessories such as hoochie 806 are perturbed to move 901-904 in a combined rotating-oscillation motion when the rotating motion-counter motion of blade portion 810 rotates fishing line 802.

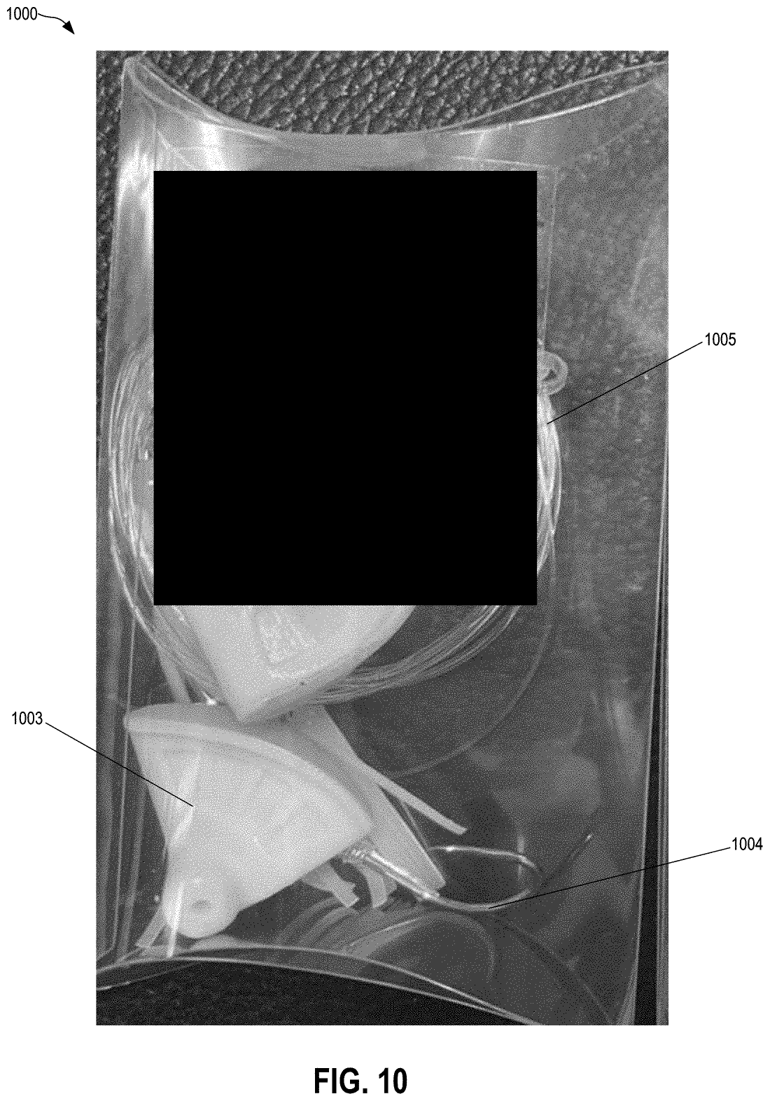

FIG. 10 depicts an exemplary view of a fishing lure packaging 1000, in accordance with described embodiments.

As shown here, fishing lure 1003 may have different colors and materials and be packaged and sold with a hook 1004 and fishing line 1005. According to certain embodiments, portions of fishing lure 1003 such as edge 803 may be different colors than other portions of fishing lure 1003. According to other embodiments, other accessories such as hoochies and connector beads may also be included in the packaging.

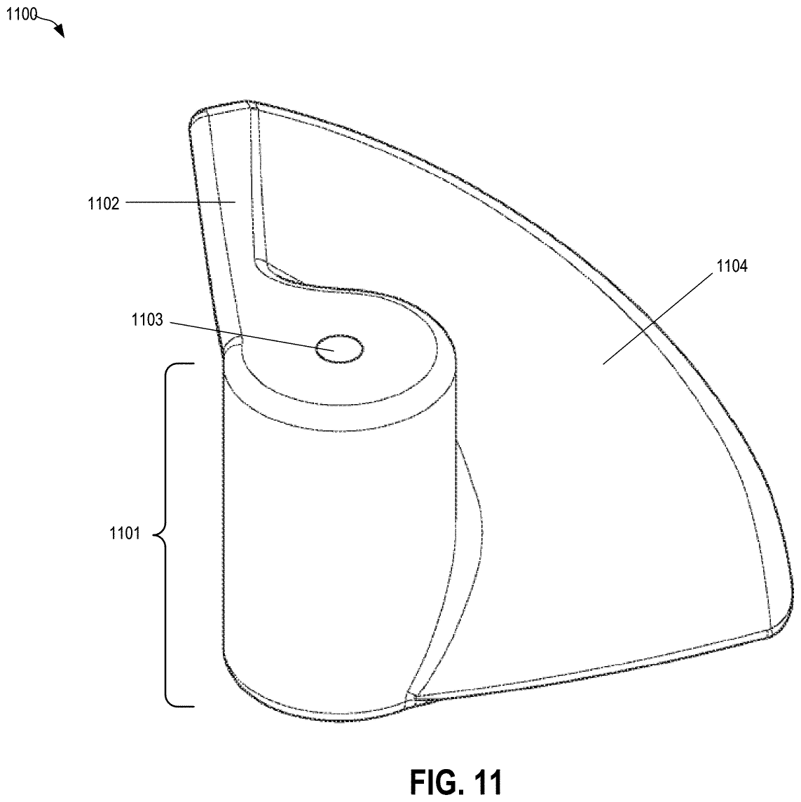

FIG. 11 depicts an exemplary view of a fishing lure 1100 in an upright orientation, in accordance with described embodiments.

As shown here, there is a base portion 1101 having an ingress opening 1103 and an asymmetrical curved blade with a smooth anterior surface 1104 radiating outward from base portion 1101 with an edge 1102.

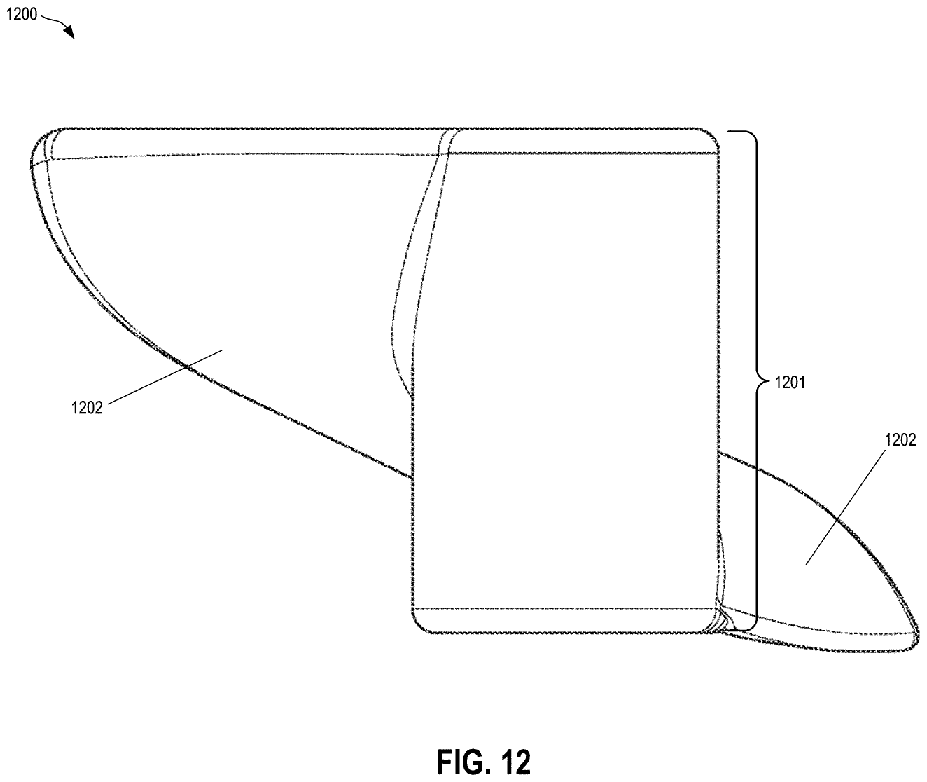

FIG. 12 depicts an exemplary flat view of a fishing lure 1200 in vertical downwards orientation, in accordance with described embodiments.

As shown here, there is a base portion 1201 having an asymmetric curved blade 1202.

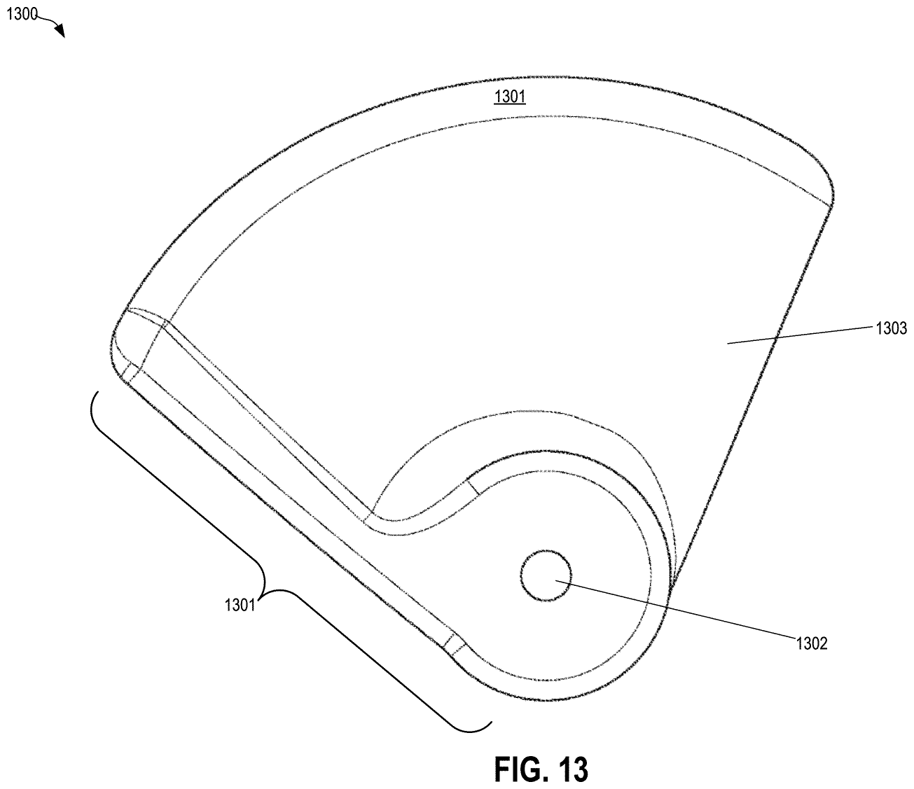

FIG. 13 depicts an exemplary posterior view of a blade 1300 for a fishing lure in an upright position, in accordance with described embodiments.

As shown here there is an opening 1302 to be concentric with a channel to receive fishing line 1005 within base portion 1101. Asymmetric blade 1300 has a posterior surface 1303 which may include integrated indentations to receive scented material to be dissipated to attract fish when fishing lure 1003 is deployed in a body of water. There is also an edge 1301 around the perimeter of asymmetric blade 1300.

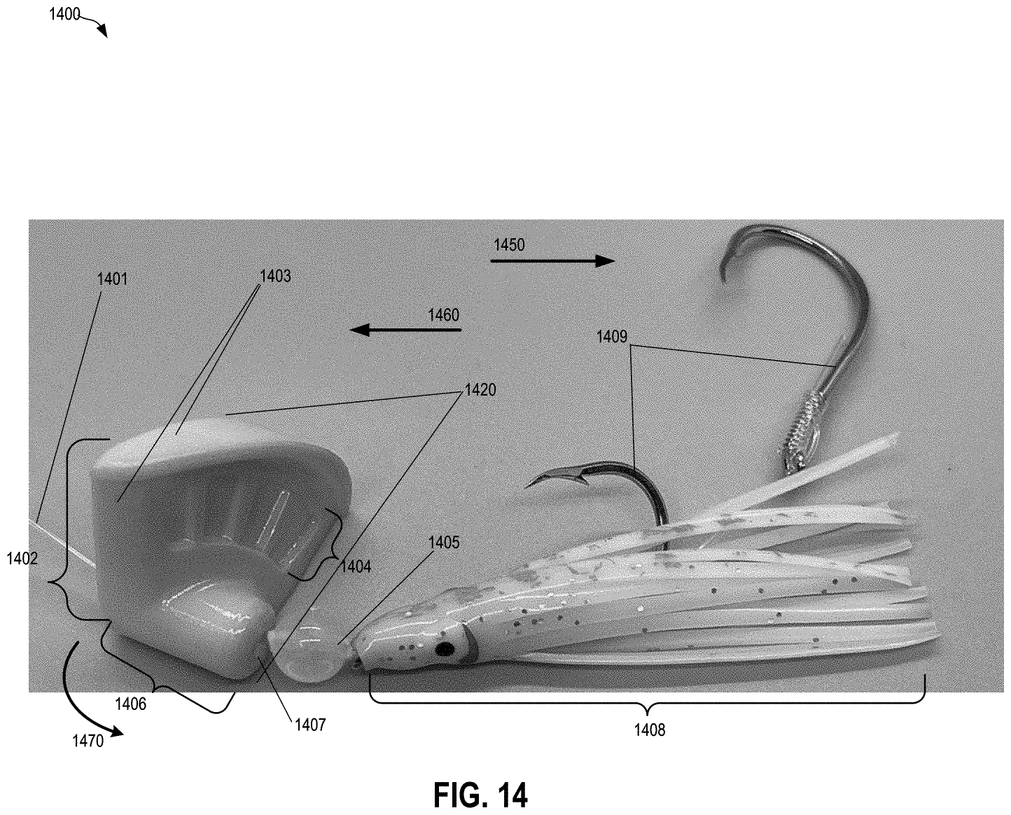

FIG. 14 depicts an exemplary view of the fishing lure in use with a fishing line, fishing bait, and hooks 1400, in accordance with described embodiments.

As shown here, fishing lure 1420 includes a base portion 1406 which includes an ingress opening on the anterior surface of base portion 1406 and an egress opening 1407 on the posterior surface of base portion 1406. Fishing lure 1420 also includes an asymmetric curved blade portion 1402 radiating outward from base portion 1406 and having a posterior blade surface and an edge 1403 around the perimeter of blade portion 1402.

According to certain embodiments, edge 1403 has a thickness configures to increase peripheral visibility of fishing lure 1420 to fish and other marine life during deployment of fishing lure 1420 and attached accessories such as hoochie 1408 and hooks 1409.

According to certain embodiments, blade portion 1402 swivels in an off-center rotating motion-counter motion of less than 360 degrees.

According to certain embodiments, blade portion 1402 may have a chrome panel of various shapes and sizes to reflect sunlight and provide long-range visual stimulation to attract fish when fishing lure 1420 with threaded fishing line 1401 and attached accessories such as connector bead 1405, hoochie 1408, and hooks 1409 are deployed in a body of water. Fishing line 1401 threads into fishing lure 1420 via the ingress opening on the anterior surface of base portion 1406, traverses through a channel in the base portion 1406 connecting the ingress opening to egress opening 1407, and exits via egress opening 1407 of base portion 1406.

As shown here, fishing bait such as hoochie 1408 may interface with connector bead 1405 posterior to egress opening 1407, with fishing line 1402 threading through connector bead 1405 and hoochie 1408. Connector bead 1405 allows hoochie 1408 to float freely as opposed to being secured to fishing lure 1420, thus translating the rotating motion-counter motion of blade portion 1402 rotating fishing line 1401 into a chirp vibrating-twitching motion when fishing lure 1420 and accessories 1405, 1408, and 1409 are deployed and moved in a body of water. Other accessories such as hooks 1409 may be connected to fishing line 1401 via threading or tying.

Fishing line 1401 may be secured upstream 1460 to a fishing vessel, for example using a bead chain swivel, or fishing tackle. Upstream 1460 is in the direction of pulling force 1460 applied to fishing line 1402 to move fishing lure 1420 and attached accessories 1405, 1408, and 1409 in a forwards direction. Counter to upstream/direction of pulling force 1460 is the direction of water flow 1450 which is downstream 1450. Direction of water flow 1450 is a resistance force against fishing lure 1420, impacting the anterior blade surface of fishing lure 1420 which serves to mitigate this force via the smooth surface of anterior blade surface and to serve as a barrier to allow for slower release of scented material held in integrated indentations 1404 of the posterior surface of blade portion 1402.

It should be further noted as shown here that there is a lack of symmetry 1470 around base portion 1406, with blade portion 1402 only radiating outward across a part of base portion 1406.

According to certain embodiments, fishing lure 1420 or system 1400 may be known as “The Wacko.”

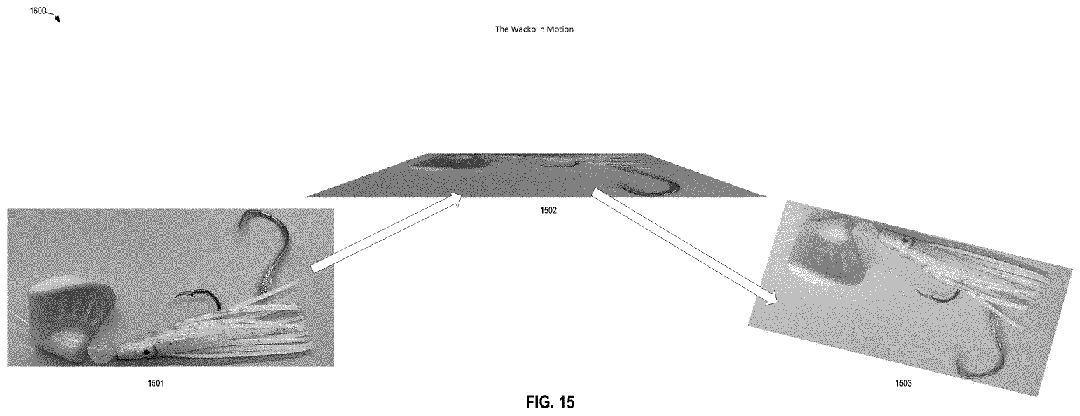

FIG. 15 depicts an exemplary view of the fishing lure in motion 1500, in accordance with described embodiments.

Fishing lure 1420 and attached accessories such as connector bead 1405 and hoochie 1408 are perturbed to move 1501-1503 in a chirp vibrating-twitching motion when the rotating motion-counter motion of blade portion 1402 rotates fishing line 1401.

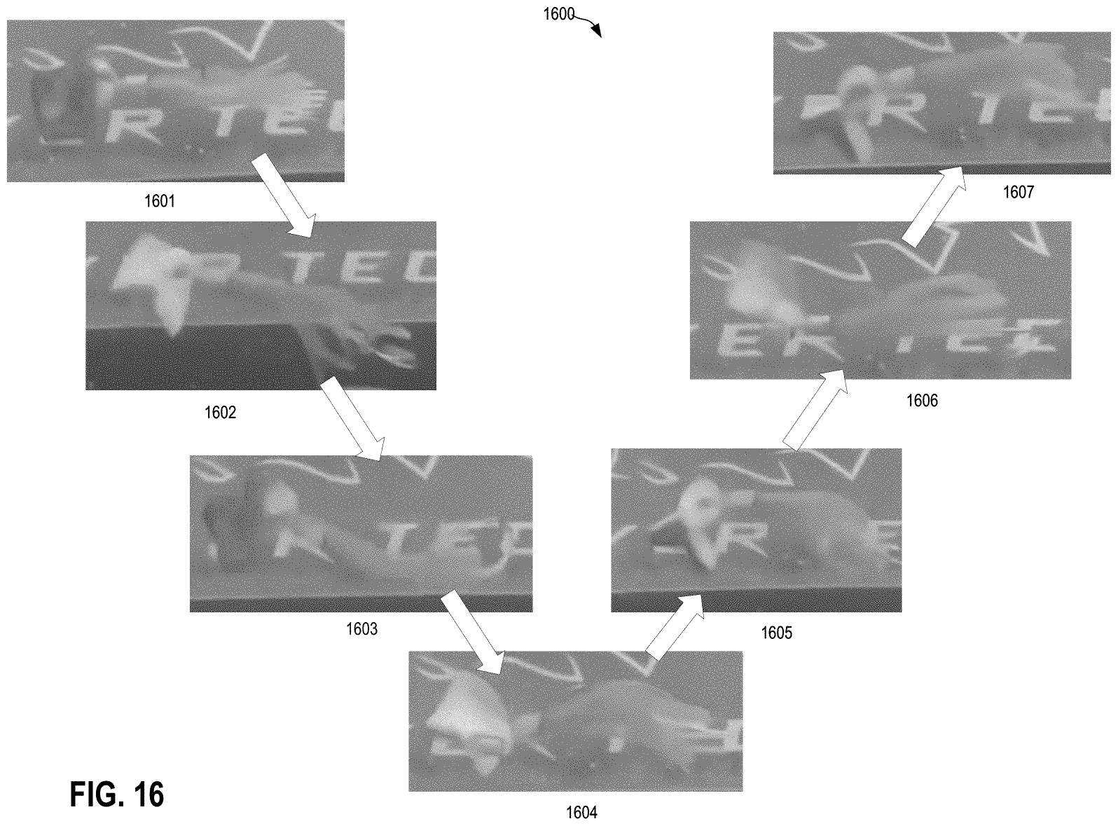

FIG. 16 depicts another exemplary view of the fishing lure in motion 1600, in accordance with described embodiments.

As shown here, fishing lure 1420 and attached accessories such as connector bead 1405, hoochie 1408, and hooks 1409 are perturbed to move 1601-1607 in a chirp vibrating-twitching motion when the rotating motion-counter motion of blade portion 1402 rotates fishing line 1401.

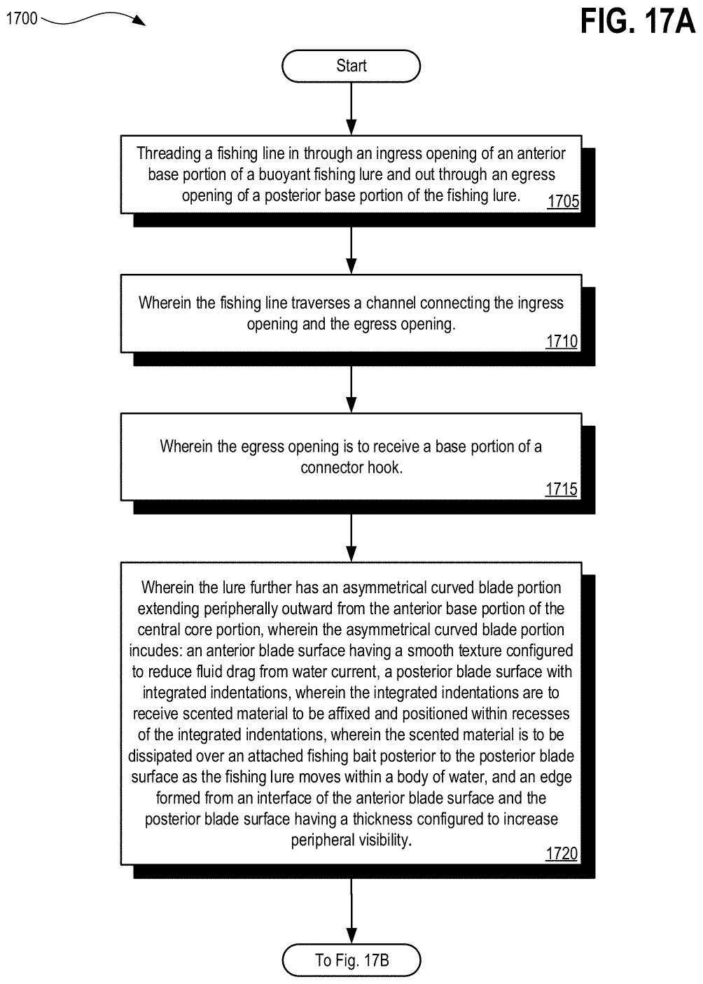

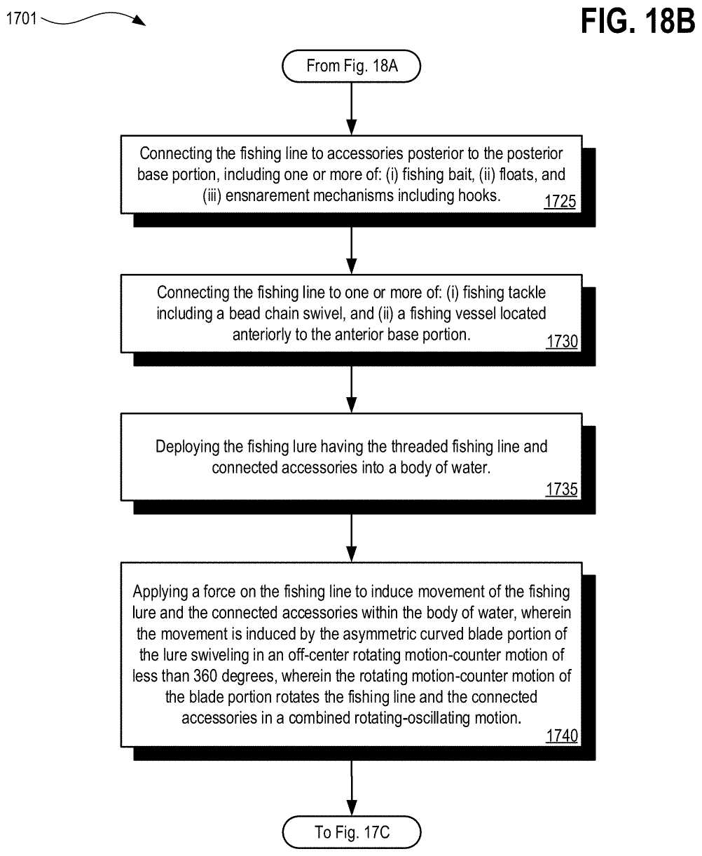

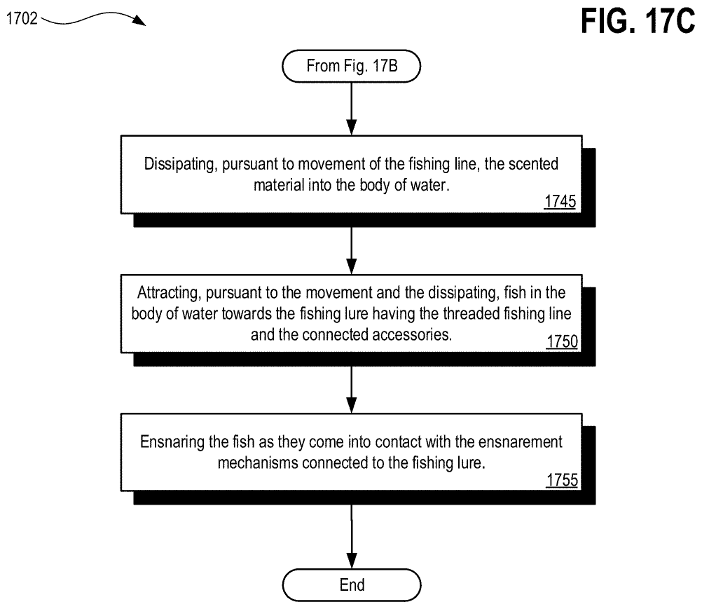

FIGS. 17A-17C depict a flow diagram 1700-1702 illustrating a method for luring fish for ensnarement via inducing fish bait mobility, in accordance with disclosed embodiments.

Some of the blocks and/or operations listed below are optional in accordance with certain embodiments. The numbering of the blocks presented is for the sake of clarity and is not intended to prescribe an order of operations in which the various blocks must occur.

With reference to the method 1700-1702 depicted at FIGS. 17A-17C beginning at block 1705, there is a method for luring fish for ensnarement via inducing fish bait motility by performing the following operations:

At block 1705, the method includes threading a fish line through an ingress opening of an anterior base portion of a buoyant fishing lure and out through an egress opening of a posterior base portion of the fishing lure.

At block 1710, the method includes the fishing line traversing a channel connecting the ingress opening and the egress opening.

At block 1715, the method includes the egress opening receiving a base portion of the connector hook.

At block 1720, the method includes the lure further having an asymmetrical curved blade portion extending peripherally outward from the anterior base portion of the central core portion, in which asymmetrical curved blade portion includes: an anterior blade surface having a smooth texture configured to reduce fluid drag from water current, a posterior blade surface with integrated indentations, in which the integrated indentations are to receive scented material to be affixed and positioned within recesses of the integrated indentations, in which the scented material is to be dissipated over an attached fishing bait posterior to the posterior blade surface as the fishing lure moves within a body of water, and an edge formed from an interface of the anterior blade surface and the posterior blade surface having a thickness configured to increase peripheral visibility.

Method 1700-1702 continues at FIG. 17B.

At block 1725, the method includes connecting the fishing line to accessories posterior to the posterior base portion, including one or more of: (i) fishing bait, (ii) floats, and (iii) ensnarement mechanisms including hooks.

At block 1730, the method includes connecting the fishing line to one or more of: (i) fishing tackle including a bead chain swivel, and (ii) a fishing vessel located anteriorly to the anterior base portion.

At block 1735, the method includes deploying the fishing lure having the threaded fishing line and connected accessories into a body of water.

At block 1740, the method includes applying a force on the fishing line to induce movement of the fishing lure and the connected accessories with the body of water, in which the movement is induced by the asymmetrical curved blade portion of the lure swiveling in an off-center rotating motion-counter motion of less than 360 degrees, in which the rotating motion-counter motion of the blade portion rotates the fishing line and the connected accessories in a combined rotating-oscillating motion.

Method 1700-1702 continues at FIG. 17C.

At block 1745, the method includes dissipating, pursuant to movement of the fishing line, the scented material into the body of water.

At block 1750, the method includes attracting, pursuant to the movement and the dissipating, fish in the body of water towards the fishing lure having the threaded fishing line and the connected accessories.

At block 1755, the method includes ensnaring the fish as they come into contact with the ensnarement mechanisms connected to the fishing lure.

According to another embodiment of method 1700-1702, there is a buoyant fishing lure to induce fish bait mobility for ensnaring fish, the lure having: a central core portion; and an asymmetrical curved blade portion; in which the central core portion includes: an anterior base portion having an ingress opening, a posterior base portion having an egress opening to receive a base portion of a connector hook, and a channel connecting the ingress opening of the anterior base and the egress opening of the posterior base, in which a fishing line is to traverse through the channel, in which the asymmetrical curved blade portion extends peripherally outward from the anterior base portion of the central core portion, in which the asymmetrical curved blade portion includes: an anterior blade surface having a smooth texture configured to reduce fluid drag from water current, a posterior blade surface with integrated indentations, in which the integrated indentations are to receive scented material to be affixed and positioned within recesses of the integrated indentations, wherein the scented material is to be dissipated over an attached fishing bait posterior to the posterior blade surface as the fishing lure moves within a body of water, and an edge forming an interface between the anterior blade surface and the posterior blade surface having a thickness configured to increase peripheral visibility, in which the asymmetric curved blade portion is configured to swivel in an off-center rotating motion-counter motion of less than 360 degrees, in which the rotating motion-counter motion of the blade portion rotates the fishing line in a combined rotating-oscillating motion.

According to another embodiment of method 1700-1702, the fishing line is to connect to accessories posterior to the egress opening, including one or more of: (i) fishing bait, (ii) floats, and (ii) ensnarement mechanisms including hooks, in which the rotating motion-counter motion of the blade portion further moves the accessories in the combined rotating-oscillating motion, in which the base portion of the connector hook locks into the egress opening to secure a first fishing bait attached to a hook portion of the connector hook, in which additional fishing bait is connected to the fishing line via the one or more hooks.

According to another embodiment of method 1700-1702, a chrome reflective panel is added to one or more of the: (i) anterior blade surface, (ii) the posterior blade surface, and (iii) the edge of the asymmetrical curved blade portion, in which the chrome reflective panel reflects light to attract fish towards the fishing lure when the fishing lure is deployed in a body of water.

According to another embodiment of method 1700-1702, the anterior blade surface reduces fluid drag from water current by absorbing and redirecting water current away from the scented material within the recesses of the integrated indentations of the posterior blade surface, allowing for slower dissipation of the scented material.

According to another embodiment of method 1700-1702, the asymmetrical curved blade portion is one more or of: (i) an auger blade, and (ii) a single-spoke blade, in which the rotating motion-counter motion of the asymmetrical curved blade portion is directed in one of a: (i) clockwise to counter-clockwise direction, or (ii) a counter-clockwise to clockwise direction, in which the asymmetrical curved blade portion lacks symmetry around the central core portion.

According to another embodiment of method 1700-1702, the fishing line attaches to one or more of: (i) a bead chain swivel, and (ii) fishing tackle located anteriorly to the anterior base portion.

According to another embodiment of method 1700-1702, the fishing lure is one or more of: (i) casted, (ii) trolled, (iii) back-trolled, and (iv) fished in a body of water.

According to another embodiment of method 1700-1702, a plurality of fishing lures are used simultaneously with the asymmetrical curved blade portion directed in one or more of a: (i) clockwise to counter-clockwise direction, and (ii) a counter-clockwise to clockwise direction.

According to another embodiment of method 1700-1702, the asymmetrical curved blade portion has a variable angle based on water dynamics in an environment that the blade is to be operated within, in which a speed of the fishing lure is based on the variable angle.

According to another embodiment of method 1700-1702, the fishing bait includes one or more of: (i) squid, (ii) fish eggs, (iii) worms, (iv) leeches, (v) insects, (vi) at least portions of fish including herring and minnows, and (vii) imitation bait including hoochies.

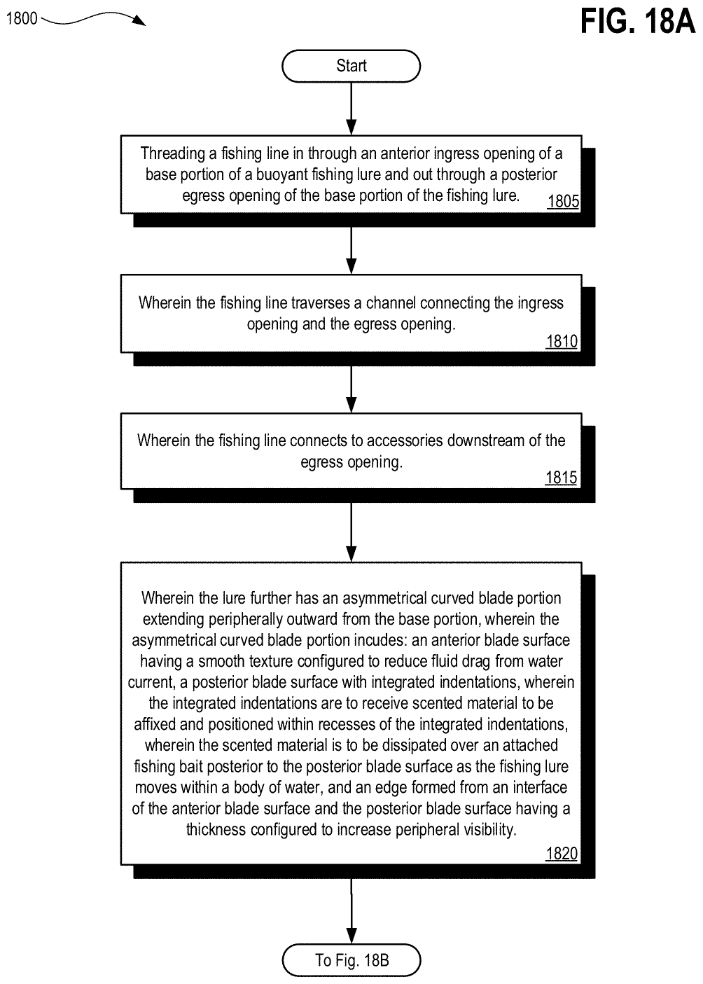

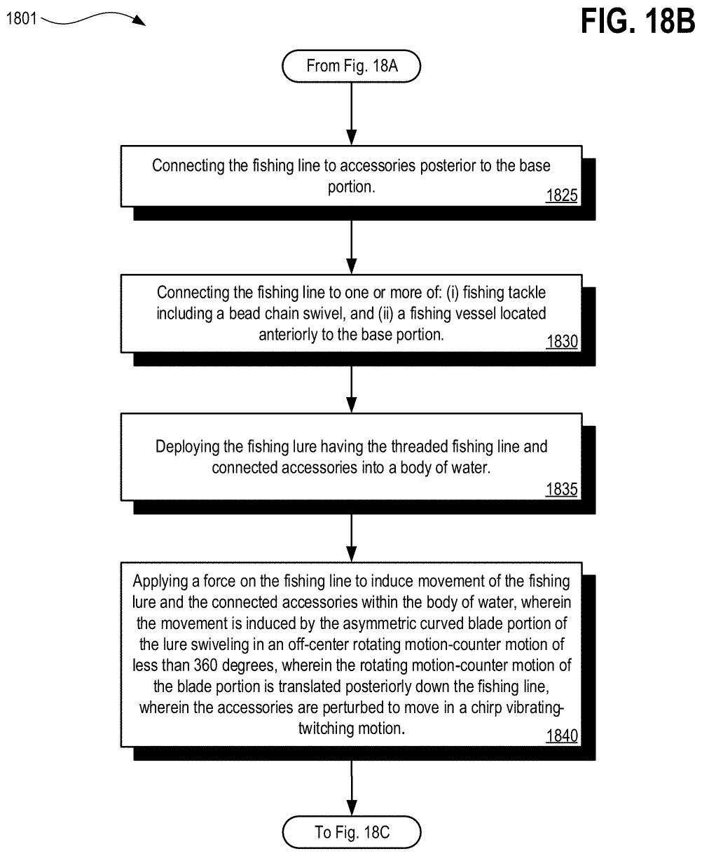

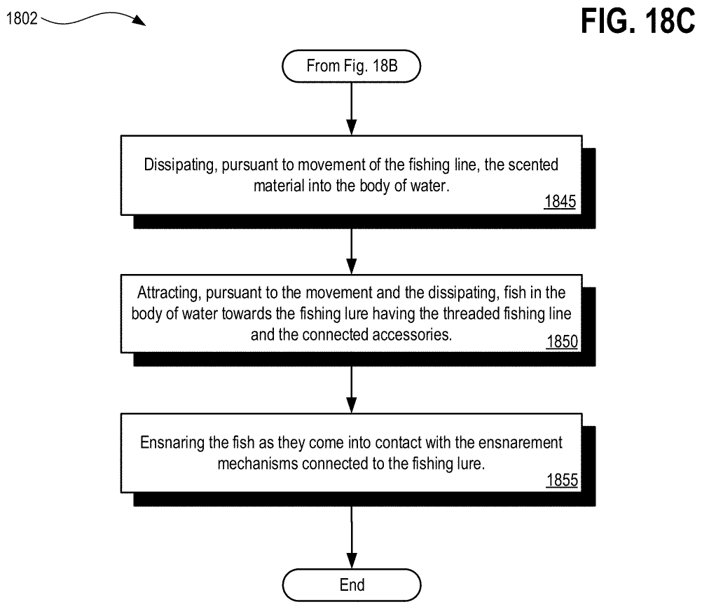

FIGS. 18A-18C depict a flow diagram 1800-1802 illustrating a method for luring fish for ensnarement via inducing fish bait mobility, in accordance with disclosed embodiments.

Some of the blocks and/or operations listed below are optional in accordance with certain embodiments. The numbering of the blocks presented is for the sake of clarity and is not intended to prescribe an order of operations in which the various blocks must occur.

With reference to the method 1800-1802 depicted at FIGS. 18A-18C beginning at block 1805, there is a method for luring fish for ensnarement via inducing fish bait motility by performing the following operations:

At block 1805, the method includes threading a fish line through an anterior ingress opening of a base portion of a buoyant fishing lure and out through a posterior egress opening of the base portion of the fishing lure.

At block 1810, the method includes the fishing line traversing a channel connecting the ingress opening and the egress opening.

At block 1815, the method includes the fishing line connecting to accessories downstream of the egress opening.

At block 1820, the method includes the lure further having an asymmetrical curved blade portion extending peripherally outward from the anterior base portion, in which asymmetrical curved blade portion includes: an anterior blade surface having a smooth texture configured to reduce fluid drag from water current, a posterior blade surface with integrated indentations, in which the integrated indentations are to receive scented material to be affixed and positioned within recesses of the integrated indentations, in which the scented material is to be dissipated over an attached fishing bait posterior to the posterior blade surface as the fishing lure moves within a body of water, and an edge formed from an interface of the anterior blade surface and the posterior blade surface having a thickness configured to increase peripheral visibility.

Method 1800-1802 continues at FIG. 18B.

At block 1825, the method includes connecting the fishing line to accessories posterior to the base portion.

At block 1830, the method includes connecting the fishing line to one or more of: (i) fishing tackle including a bead chain swivel, and (ii) a fishing vessel located anteriorly to the anterior base portion.

At block 1835, the method includes deploying the fishing lure having the threaded fishing line and connected accessories into a body of water.

At block 1840, the method includes applying a force on the fishing line to induce movement of the fishing lure and the connected accessories with the body of water, in which the movement is induced by the asymmetric curved blade portion of the lure swiveling in an off-center rotating motion-counter motion of less than 360 degrees, in which the rotating motion-counter motion of the blade portion is translated posteriorly down the fishing line, in which the accessories are perturbed to move in a chirp vibrating-twitching motion.

Method 1800-1802 continues at FIG. 18C.

At block 1845, the method includes dissipating, pursuant to movement of the fishing line, the scented material into the body of water.

At block 1850, the method includes attracting, pursuant to the movement and the dissipating, fish in the body of water towards the fishing lure having the threaded fishing line and the connected accessories.

At block 1855, the method includes ensnaring the fish as they come into contact with the connected accessories.

According to another embodiment of method 1800-1802, there is a buoyant fishing lure to induce fish bait mobility for ensnaring fish, the lure having: a base portion; and an asymmetrical curved blade portion; in which the base portion has: an anterior ingress opening, a posterior egress opening, and a channel traversing through the base portion connecting the ingress opening and the egress opening, in which the channel is to receive a fishing line, in which the fishing line connects to accessories downstream of the egress opening, in which the asymmetrical curved blade portion extends peripherally outward from the anterior base portion of the central core portion, in which the asymmetrical curved blade portion includes: an anterior blade surface having a smooth texture configured to reduce fluid drag from water current, a posterior blade surface with integrated indentations, in which the integrated indentations are to receive scented material to be affixed and positioned within recesses of the integrated indentations, in which the scented material is to be dissipated over an attached fishing bait posterior to the posterior blade surface as the fishing lure moves within a body of water, and an edge formed from an interface of the anterior blade surface and the posterior blade surface having a thickness configured to increase peripheral visibility, in which the blade portion swivels in an off-center rotating motion-counter motion of less than 360 degrees, in which the rotating motion-counter motion of the blade is translated posteriorly down the fishing line, in which the accessories are perturbed to move in a chirp vibrating-twitching motion.

According to another embodiment of method 1800-1802, the accessories connected to the fishing line downstream of egress opening include one or more of: (i) a bead connector, (ii) fishing bait, and (iii) hooks.

According to another embodiment of method 1800-1802, light is emitted from the fishing lure via a blinking bead located on one more of: (i) the blade, (ii) the bead connector, (iii) the fishing bait, and (iv) the hooks.

According to another embodiment of method 1800-1802, connecting the fishing line to the accessories includes one or more of: (i) traversing the fishing line through openings in the accessories, and (ii) tying the fishing line to the accessories.

According to another embodiment of method 1800-1802, the accessories connected to the fishing line downstream of egress opening include one or more of: (i) a bead connector, (ii) fishing bait, and (iii) hooks.

According to another embodiment of method 1800-1802, the anterior blade surface reduces fluid drag from water current by absorbing and redirecting water current away from the scented material within the recesses of the integrated indentations of the posterior blade surface, allowing for slower dissipation of the scented material.

None of the claims are intended to invoke paragraph six of 35 U.S.C. § 112 unless the exact words “means for” are followed by a participle. While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A buoyant fishing lure (“lure”) to induce fish bait mobility for ensnaring fish, the lure having:
a central core portion; and
an asymmetrical curved blade portion;
wherein the central core portion includes:
an anterior base portion having an ingress opening,
a posterior base portion having an egress opening to receive a base portion of a connector hook, and
a channel connecting the ingress opening of the anterior base and the egress opening of the posterior base, wherein a fishing line is to traverse through the channel,
wherein the asymmetrical curved blade portion extends peripherally outward from the anterior base portion of the central core portion, wherein the asymmetrical curved blade portion includes:
an anterior blade surface having a smooth texture configured to reduce fluid drag from water current,
a posterior blade surface with integrated indentations, wherein the integrated indentations are to receive scented material to be affixed and positioned within recesses of the integrated indentations, wherein the scented material is to be dissipated over an attached fishing bait posterior to the posterior blade surface as the fishing lure moves within a body of water, and
an edge forming an interface between the anterior blade surface and the posterior blade surface having a thickness configured to increase peripheral visibility,
wherein the asymmetric curved blade portion is configured to swivel in an off-center rotating motion-counter motion of less than 360 degrees, wherein the rotating motion-counter motion of the blade portion rotates the fishing line in a combined rotating-oscillating motion.

2. The fishing lure of claim 1, wherein the fishing line is to connect to accessories posterior to the egress opening, including one or more of: (i) fishing bait, (ii) floats, and (ii) ensnarement mechanisms including hooks, wherein the rotating motion-counter motion of the blade portion further moves the accessories in the combined rotating-oscillating motion, wherein the base portion of the connector hook locks into the egress opening to secure a first fishing bait attached to a hook portion of the connector hook, wherein additional fishing bait are connected to the fishing line via the one or more hooks.

3. The fishing lure of claim 1, wherein a chrome reflective panel is added to one or more of the:
(i) anterior blade surface, (ii) the posterior blade surface, and (iii) the edge of the asymmetrical curved blade portion, wherein the chrome reflective panel reflects light to attract fish towards the fishing lure when the fishing lure is deployed in a body of water.

4. The fishing lure of claim 1, wherein the anterior blade surface reduces fluid drag from water current by absorbing and redirecting water current away from the scented material within the recesses of the integrated indentations of the posterior blade surface, allowing for slower dissipation of the scented material.

5. The fishing lure of claim 1, wherein the asymmetrical curved blade portion is one more or of:
(i) an auger blade, and (ii) a single-spoke blade, wherein the rotating motion-counter motion of the asymmetrical curved blade portion is directed in one of a: (i) clockwise to counter-clockwise direction, or (ii) a counter-clockwise to clockwise direction, wherein the asymmetrical curved blade portion lacks symmetry around the central core portion.

6. The fishing lure of claim 1, wherein the fishing line attaches to one or more of: (i) a bead chain swivel, and (ii) fishing tackle located anteriorly to the anterior base portion.

7. The fishing lure of claim 1, wherein the fishing lure is one or more of: (i) casted, (ii) trolled,
(iii) back-trolled, and (iv) fished in a body of water.

8. The fishing lure of claim 1, wherein a plurality of fishing lures are used simultaneously with the asymmetrical curved blade portion directed in one or more of a: (i) clockwise to counter-clockwise direction, and (ii) a counter-clockwise to clockwise direction.

9. The fishing lure of claim 1, wherein the asymmetrical curved blade portion has a variable angle based on water dynamics in an environment that the blade is to be operated within, wherein a speed of the fishing lure is based on the variable angle.

10. The fishing lure of claim 2, wherein the fishing bait includes one or more of: (i) squid, (ii) fish eggs, (iii) worms, (iv) leeches, (v) insects, (vi) at least portions of fish including herring and minnows, and (vii) imitation bait including hoochies.

11. A method for luring fish for ensnarement via inducing fish bait mobility, the method comprising:
threading a fishing line in through an ingress opening of an anterior base portion of a buoyant fishing lure and out through an egress opening of a posterior base portion of the fishing lure,
wherein the fishing line traverses a channel connecting the ingress opening and the egress opening,
wherein the egress opening is to receive a base portion of a connector hook, wherein the lure further has an asymmetrical curved blade portion extending peripherally outward from the anterior base portion of the central core portion, wherein the asymmetrical curved blade portion includes:
an anterior blade surface having a smooth texture configured to reduce fluid drag from water current,
a posterior blade surface with integrated indentations, wherein the integrated indentations are to receive scented material to be affixed and positioned within recesses of the integrated indentations, wherein the scented material is to be dissipated over an attached fishing bait posterior to the posterior blade surface as the fishing lure moves within a body of water, and
an edge formed from an interface of the anterior blade surface and the posterior blade surface having a thickness configured to increase peripheral visibility;
connecting the fishing line to accessories posterior to the posterior base portion, including one or more of: (i) fishing bait, (ii) floats, and (iii) ensnarement mechanisms including hooks;
connecting the fishing line to one or more of: (i) fishing tackle including a bead chain swivel, and (ii) a fishing vessel located anteriorly to the anterior base portion;
deploying the fishing lure having the threaded fishing line and connected accessories into a body of water;
applying a force on the fishing line to induce movement of the fishing lure and the connected accessories within the body of water, wherein the movement is induced by the asymmetrical curved blade portion of the lure swiveling in an off-center rotating motion-counter motion of less than 360 degrees, wherein the rotating motion-counter motion of the blade portion rotates the fishing line and the connected accessories in a combined rotating-oscillating motion;
dissipating, pursuant to the movement of the fishing line, the scented material into the body of water;
attracting, pursuant to the movement and the dissipating, fish in the body of water towards the fishing lure having the threaded fishing line and the connected accessories; and
ensnaring the fish as they come into contact with the ensnarement mechanisms connected to the fishing lure.

12. The method of claim 11, wherein connecting the fishing line to the accessories includes one or more of: (i) traversing the fishing line through openings in the accessories, and (ii) tying the fishing line to the accessories.

13. The method of claim 11, wherein the movement causes one or more of (i) visual stimuli, (ii) auditory stimuli, and (iii) water vibrations to attract the fish.

14. The method of claim 11, wherein a castable sonar fish finder is utilized to locate the fish within the body of water, wherein the fishing lure having the threaded fishing line and connected accessories are positioned in the vicinity of the fish.

15. A buoyant fishing lure to induce fish bait mobility for ensnaring fish, the lure having:
a base portion; and
an asymmetrical curved blade portion;
wherein the base portion has:
an anterior ingress opening,
a posterior egress opening, and
a channel traversing through the base portion connecting the ingress opening and the egress opening, wherein the channel is to receive a fishing line, wherein the fishing line connects to accessories downstream of the egress opening,
wherein the asymmetrical curved blade portion extends peripherally outward from the anterior base portion of the central core portion, wherein the asymmetrical curved blade portion includes:
an anterior blade surface having a smooth texture configured to reduce fluid drag from water current,
a posterior blade surface with integrated indentations, wherein the integrated indentations are to receive scented material to be affixed and positioned within recesses of the integrated indentations, wherein the scented material is to be dissipated over an attached fishing bait posterior to the posterior blade surface as the fishing lure moves within a body of water, and
an edge formed from an interface of the anterior blade surface and the posterior blade surface having a thickness configured to increase peripheral visibility,
wherein the blade portion swivels in an off-center rotating motion-counter motion of less than 360 degrees, wherein the rotating motion-counter motion of the blade is translated posteriorly down the fishing line, wherein the accessories are perturbed to move in a chirp vibrating-twitching motion.

16. The fishing lure of claim 15:
wherein the accessories connected to the fishing line downstream of egress opening include one or more of: (i) a bead connector, (ii) fishing bait, and (iii) hooks, and
wherein light is emitted from the fishing lure via a blinking bead located on one more of: (i) the blade, (ii) the bead connector, (iii) the fishing bait, and (iv) the hooks.

17. The fishing lure of claim 15, wherein a plurality of fishing lures are used simultaneously with the asymmetrical curved blade portion directed in one or more of a: (i) clockwise to counter-clockwise direction, and (ii) a counter-clockwise to clockwise direction.

18. The fishing lure of claim 15, wherein the asymmetrical curved blade portion has a variable angle based on water dynamics in an environment that the blade is to be operated within, wherein a speed of the fishing lure is based on the variable angle.

19. The fishing lure of claim 15, wherein the fishing bait includes one or more of: (i) squid, (ii) fish eggs, (iii) worms, (iv) leeches, (v) insects, (vi) at least portions of fish including herring and minnows, and (vii) imitation bait including hoochies.

20. The fishing lure of claim 15, wherein the asymmetrical curved blade portion is one more or of: (i) an auger blade, and (ii) a single-spoke blade, wherein the rotating motion-counter motion of the asymmetrical curved blade portion is directed in one of a: (i) clockwise to counter-clockwise direction, or (ii) a counter-clockwise to clockwise direction, wherein the asymmetrical curved blade portion lacks symmetry around the central core portion.
